(19) United States
(12) Patent Application Publication
(10) Pub. No.: US 2024/0007718 A1
(43) Pub. Date: Jan. 4, 2024

(54) MULTIMEDIA BROWSING METHOD AND APPARATUS, DEVICE AND MEDIUIM

(71) Applicant: BEIJING ZITIAO NETWORK TECHNOLOGY CO., LTD., Beijing (CN)

(72) Inventors: Bixing SHENG, Beijing (CN); Zhangyi LI, Beijing (CN); Shenghui ZHANG, Beijing (CN)

(21) Appl. No.: 18/037,288

(22) PCT Filed: Nov. 16, 2021
(86) PCT No.: PCT/CN2021/130998

§ 371 Date: May 16, 2023

(30) Foreign Application Priority Data
Nov. 18, 2020 (CN) 202011296617.4

(51) Int. Cl. H04N 21/488; G06F 16/44; G10L 15/18; H04N 21/8547

(52) U.S. Cl. CPC H04N 21/4884; G06F 16/44; G10L 15/1822; H04N 21/8547; G10L 2015/088

(57) ABSTRACT

A multimedia browsing method and apparatus, a device, and a medium. The method comprises: receiving a caption browsing request of target multimedia; acquiring at least two multimedia segments of the target multimedia and caption segments corresponding to the multimedia segments, wherein the multimedia segments correspond to at least one caption segment; and displaying the multimedia segments in a first display area in a content display interface, and displaying, in a second display area, the caption segment corresponding to the multimedia segments. The method can implement that a plurality of multimedia segments of multimedia and a plurality of corresponding caption segments are completely displayed in different display areas, respectively, so that a user can quickly browse the caption content of the multimedia in the scenario where multimedia playback is not convenient, thereby satisfying the reading requirements of the user on the multimedia content in a special scenario.

### CROSS REFERENCE TO RELATED APPLICATIONS

The present application is proposed based on and claims the priority of the Chinese patent application No. 202011296617.4, filed on Nov. 18, 2020, and entitled “MULTIMEDIA BROWSING METHOD AND APPARATUS, DEVICE AND MEDIUM”, the entire contents of which are incorporated herein by reference.

### FIELD

The present disclosure relates to the field of multimedia technology, in particular to a multimedia browsing method and apparatus, a device and a medium.

### BACKGROUND

With the continuous development of smart devices and multimedia technology, browsing multimedia in the smart devices has increasingly become an indispensable part in people's lives.

The playback of multimedia is usually limited by scenarios. For example, it is often not suitable to play multimedia in meetings or work. However, it is often necessary to know the content of the multimedia at the same time in the above-mentioned scenarios.

### SUMMARY

In order to solve the above technical problems or at least partially solve the above technical problems, the present disclosure provides a multimedia browsing method, apparatus, device and medium.

Embodiment of the present disclosure provides a multimedia browsing method, the method comprises: receiving a subtitle browsing request for target multimedia; acquiring at least two multimedia segments of the target multimedia and subtitle segments corresponding to the multimedia segments, wherein the multimedia segments corresponds to at least one of the subtitle segments; and displaying the multimedia segments in a first display area in a content display interface, and displaying the subtitle segments corresponding to the multimedia segments in a second display area.

Another embodiment of the present disclosure provides A multimedia browsing apparatus, the apparatus comprises: a browsing request receiving module configured to receive a subtitle browsing request for target multimedia; a content acquisition module configured to acquire at least two multimedia segments of the target multimedia and subtitle segments corresponding to the multimedia segments, wherein the multimedia segments corresponds to at least one of the subtitle segments; and a content display module configured to display the multimedia segments in a first display area in a content display interface, and display the subtitle segments corresponding to the multimedia segments in a second display area.

Another embodiment of the present disclosure provides an electronic device, the electronic device comprises: a processor, and a memory configured to store an executable instruction for the processor; wherein the processor is configured to read the executable instruction from the memory and execute the instruction to implement the multimedia browsing method provided by embodiments of the present disclosure.

Another embodiment of the present disclosure provides a computer-readable storage medium, wherein the storage medium stores a computer program, and the computer program is configured to perform the multimedia browsing method provided by embodiments of the present disclosure.

Compared with the prior art, technical solutions provided in embodiments of the present disclosure have the following advantages: according to a multimedia browsing solution provided in an embodiment of the present disclosure, a subtitle browsing request for target multimedia is received; at least two multimedia segments of the target multimedia and subtitle segments corresponding to the multimedia segments are acquired, wherein each of the multimedia segments corresponds to at least one of the subtitle segments; and the multimedia segments are displayed in a first display area in a content display interface, and the subtitle segments corresponding to the multimedia segments are displayed in a second display area. By adopting the above-mentioned technical solution, a plurality of multimedia segments of the multimedia and the plurality of corresponding subtitle segments can be completely displayed in the different display areas, respectively, so that a user can rapidly browse a subtitle content of the multimedia in a scenario where it is inconvenient to play the multimedia, a user requirement for reading the content of the multimedia is satisfied, and the user's experience effect of browsing the content of the multimedia is improved.

### BRIEF DESCRIPTION OF THE DRAWINGS

These and other features, advantages and aspects of embodiments of the present disclosure will become more apparent in conjunction with the accompanying drawings and with reference to the following specific embodiments. Throughout the accompanying drawings, identical or similar appended markings indicate identical or similar elements. It should be understood that the accompanying drawings are schematic and that the components and elements are not necessarily drawn to scale.

FIG. 1 is a flow chart of a multimedia browsing method provided in an embodiment of the present disclosure;

FIG. 2 is a schematic diagram of a content display interface provided in an embodiment of the present disclosure;

FIG. 3 is a schematic diagram of another content display interface provided in an embodiment of the present disclosure;

FIG. 4 is a schematic diagram of yet another content display interface provided in an embodiment of the present disclosure;

FIG. 5 is a schematic structural diagram of a multimedia browsing apparatus provided in an embodiment of the present disclosure; and

FIG. 6 is a schematic structural diagram of an electronic device provided in an embodiment of the present disclosure.

### DETAILED DESCRIPTION OF THE EMBODIMENTS

Embodiments of the present disclosure will be described in greater detail below with reference to the accompanying drawings. While certain embodiments of the present disclosure are shown in the accompanying drawings, it should be understood that the present disclosure may be implemented in various forms and should not be construed as being limited to the embodiments set forth herein, but instead are provided for a more thorough and complete understanding of the present disclosure. It should be understood that the accompanying drawings and embodiments of the present disclosure are for exemplary purposes only and are not intended to limit the scope of protection of the present disclosure.

It should be understood that the individual steps documented in the method embodiments of the present disclosure may be performed in a different order, and/or in parallel. In addition, the method embodiments may include additional steps and/or omit to perform the steps illustrated. The scope of the present disclosure is not limited in this regard.

As used herein, the term “including” and variations thereof are open-ended, i.e., “including, but not limited to”. The term “based on” is “based, at least in part, on”. The term “an embodiment” means “at least one embodiment”; the term “another embodiment” means “at least one additional embodiment”; the term “some embodiments” means “at least some embodiments”. Definitions of other terms will be given in the description below.

It is noted that the concepts “first” and “second” mentioned in this disclosure are used only to distinguish between different devices, modules or units, and are not intended to define the order or interdependence of the functions performed by these devices, modules or units.

It is noted that the modifications of “one” and “more than one” mentioned in this disclosure are schematic and not limiting, and it should be understood by those skilled in the art that unless the context clearly indicates otherwise, they should be understood as “one or more” unless the context clearly indicates otherwise.

The names of the messages or information interacting between the plurality of devices in this disclosure are for illustrative purposes only and are not intended to limit the scope of those messages or information.

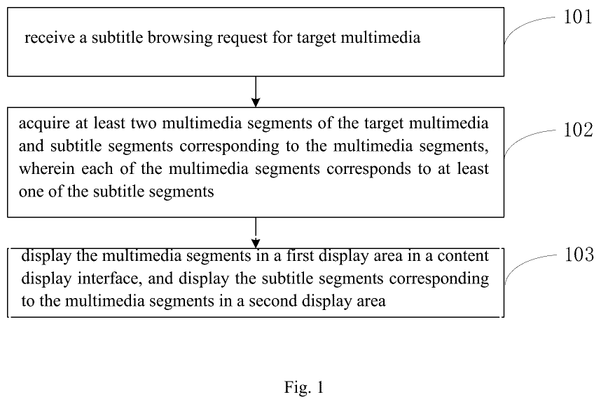

FIG. 1 is a flow chart of a multimedia browsing method provided in an embodiment of the present disclosure. The method may be executed by a multimedia browsing apparatus, wherein the apparatus may be implemented by adopting software and/or hardware and generally integrated in an electronic device. As shown in FIG. 1, the method includes the following steps.

Step 101, a subtitle browsing request for target multimedia is received.

The target multimedia may be multimedia that a user currently has a browsing requirement. In the embodiment of the present disclosure, the type, source, format, or the like of the target multimedia are not limited, and the target multimedia may include an audio and/or video. The subtitle browsing request may be understood as a request for browsing entire subtitles of multimedia based on the multimedia when it is inconvenient for a user to play the multimedia in a specific scenario. For example, subtitles of multimedia need to be browsed in a conference scenario, so that the entire content of the multimedia is known.

In the embodiment of the present disclosure, a client may receive the subtitle browsing request for the target multimedia on a multimedia display page of the target multimedia, and a specific receiving manner is not limited. For example, if it is detected that the user triggers a set button on the multimedia display page, the subtitle browsing request for the target multimedia may be received, and a specific position of the set button on the multimedia display page is not limited.

Step 102, at least two multimedia segments of the target multimedia and subtitle segments corresponding to the multimedia segments are acquired, wherein each of the multimedia segments corresponds to at least one of the subtitle segments.

The multimedia segments refer to clips obtained by splitting the target multimedia, the subtitle segments refer to clips obtained by splitting a subtitle content obtained by recognizing the target multimedia, each of the multimedia segments corresponds to at least one subtitle segment, that is, one multimedia segment may correspond to one subtitle segment or correspond to a plurality of subtitle segments.

In the embodiment of the present disclosure, before step 102 is performed, the multimedia browsing method may further include: automatic speech recognition is performed on the target multimedia to acquire a subtitle content; and semantic splitting is performed on the subtitle content to determine at least two subtitle segments. Optionally, the multimedia browsing method further includes the following step: the target multimedia is split according to time stamps corresponding to the subtitle segments to determine at least two multimedia segments.

An ASR (Automatic Speech Recognition) technology is adopted for the target multimedia, so that speech in the target multimedia may be recognized and may be converted into a subtitle content. In the embodiment of the present disclosure, a specific automatic speech recognition technology is not limited, for example, a random model method or an artificial neural network method, etc., may be adopted. Then, semantic splitting may be performed on the subtitle content to split the subtitle content into at least two subtitle segments, each of the subtitle segments may include a part of the subtitle content, and the number of the subtitle segments is not limited either. After the subtitle segments are determined, since each of the subtitle segments corresponds to a time stamp of target multimedia, the target multimedia may be split based on a time stamp corresponding to each of the subtitle segments to determine at least two corresponding multimedia segments.

Optionally, the multimedia browsing method further includes the following steps: the target multimedia is split according to a predetermined rule to determine at least two multimedia segments; and at least two corresponding subtitle segments are determined according to the multimedia segments. The predetermined rule may be set according to an actual situation, which is not specifically limited, for example, the predetermined rule may be based on time or a scenario in the multimedia. The target multimedia may also be split into at least two multimedia segments according to the predetermined rule, and then, a subtitle content obtained by performing automatic speech recognition on the target multimedia may be split based on a time stamp of each of the multimedia segments, or automatic speech recognition is performed on each of the multimedia segments, and thus, corresponding subtitle segments may be obtained.

In the embodiment of the present disclosure, after the subtitle browsing request for the target multimedia is acquired, a plurality of multimedia segments of the target multimedia obtained by processing in advance and a plurality of corresponding subtitle segments may be acquired, or the target multimedia may also be processed in real time to obtain a plurality of multimedia segments and a plurality of corresponding subtitle segments. Optionally, the above-mentioned subtitle segments and multimedia segments may also be determined in advance by a server. When the client receives the subtitle browsing request and feeds the subtitle browsing request back to the server, the server returns the subtitle segments and the multimedia segments to the client, which is not specifically limited.

Step 103, the multimedia segments are displayed in a first display area in a content display interface, and the subtitle segments corresponding to the multimedia segments are displayed in a second display area.

The content display interface refers to an interface for displaying the multimedia segments and the subtitle segments of the target multimedia. The first display area refers to an area disposed in the content display interface and configured to display the multimedia segments. The second display area refers to an area disposed in the content display interface and configured to display the subtitle segments. Specific positions of the first display area and the second display area are not limited, for example, the first display area and the second display area may be horizontally or vertically aligned to each other.

After the at least two multimedia segments of the target multimedia and the at least two corresponding subtitle segments are acquired, each of the multimedia segments may be displayed in the first display area of the content display interface, and each of the subtitle segments may be displayed in the second display area.

Optionally, a plurality of multimedia display boxes may be disposed in the first display area, and each of the multimedia display boxes is configured to display one of the multimedia segments. A plurality of subtitle display boxes may be disposed in the second display area, and each of the subtitle display boxes is configured to display one of the subtitle segments. The center of one of the multimedia display boxes may be aligned to the center of one of the subtitle display boxes.

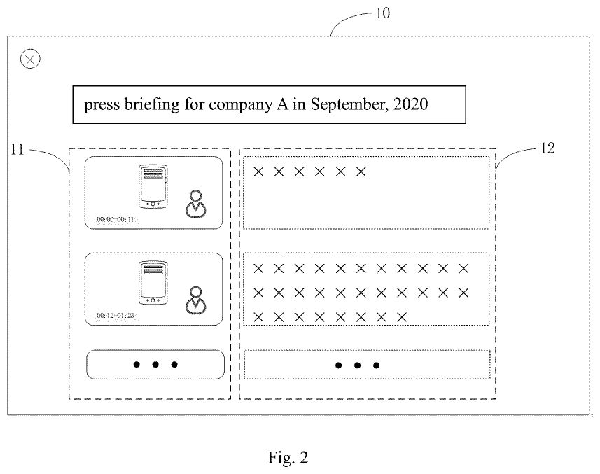

Exemplarily, FIG. 2 is a schematic diagram of a content display interface provided in an embodiment of the present disclosure. As shown in FIG. 2, a content display interface 10 is exemplarily shown. The content display interface 10 is provided with a first display area 11 and a second display area 12. The first display area 11 includes a plurality of multimedia display boxes configured to display a plurality of multimedia segments. Taking video segments as an example in the figure, two multimedia display boxes respectively displaying two video segments within time ranges of “00:00-00:11” and “00:12-00:23” are shown in the figure. The second display area 12 includes a plurality of subtitle display boxes configured to display a plurality of subtitle segments, and two subtitle display boxes are shown in the figure. In FIG. 2, the center of the multimedia display box of one of the multimedia segments and the center of the subtitle display box of the multimedia segment are aligned for display, which is beneficial for a user to browse by contrast. The content display interface 10 in the figure may further display a multimedia title “Press Briefing for Company A in September, 2020”.

According to a multimedia browsing solution provided in an embodiment of the present disclosure, a subtitle browsing request for target multimedia is received. At least two multimedia segments of the target multimedia and subtitle segments corresponding to the multimedia segments are acquired, wherein each of the multimedia segments corresponds to at least one subtitle segment. The multimedia segments are displayed in a first display area in a content display interface, and the subtitle segments corresponding to the multimedia segments are displayed in a second display area. By adopting the above-mentioned technical solution, a plurality of multimedia segments of the multimedia and a plurality of corresponding subtitle segments can be completely displayed in the different display areas, respectively, so that a user can rapidly browse a subtitle content of the multimedia in a scenario where it is inconvenient to play the multimedia, a user requirement for reading the content of the multimedia is satisfied, and the user's experience effect of browsing the content of the multimedia is improved.

In some embodiments, the multimedia browsing method may further include that a time stamp of each subtitle sentence included in the subtitle segments is determined, wherein the subtitle sentence includes at least one word or phrase. The subtitle content belongs to a structured text, which is of a three-tier structure including a paragraph, a sentence and a phrase, the subtitle sentence is a sentence in the subtitle content, and a subtitle sentence may include at least one word or phrase. Since the subtitle segments are obtained by performing automatic speech recognition on the target multimedia, each subtitle sentence in the subtitle segments has a corresponding speech statement, each speech statement corresponds to a time stamp in the target multimedia, and the time stamp of each subtitle sentence included in the subtitle segments may be determined based on a corresponding relationship among the subtitle sentence, the speech statement and play time of the target multimedia. Such setting has the advantage that, determination of the time stamp of each subtitle sentence in the subtitle segments is prepared for the subsequent linkage interaction between a subtitle and the multimedia may be implemented, which is beneficial to the rapid implementation of linkage interaction.

In some embodiments, the multimedia browsing method may further include that a playback triggering operation of the user is received, and a first multimedia segment corresponding to the playback triggering operation in the target multimedia is played. Optionally, when the target multimedia is a video, the playing is performed in a mute manner. Optionally, the multimedia browsing method may further include the following step: subtitle sentences corresponding to a playing progress of the first multimedia segment are highlighted in sequence based on the time stamp of each subtitle sentence in the subtitle segment corresponding to the first multimedia segment in a process of playing the first multimedia segment.

The playback triggering operation refers to a triggering operation for playing the multimedia, and the playback triggering operation may have a plurality of specific forms which are not specifically limited. The first multimedia segment refers to a multimedia segment corresponding to the playback triggering operation. After the playback triggering operation of the user is received, when the target multimedia is a video, the first multimedia segment in the target multimedia may be played in a mute manner. When the target multimedia is an audio, the first multimedia segment may be played directly. Then, the subtitle segment corresponding to the first multimedia segment may be determined based on the time stamp of each subtitle sentence in the above-mentioned subtitle segments determined in advance, and the subtitle sentences corresponding to the playing progress of the first multimedia segment are highlighted in sequence based on the time stamp of each subtitle sentence in the subtitle segment corresponding to the first multimedia segment in a process of playing the first multimedia segment, that is, the subtitle sentences in the subtitle segments are highlighted in sequence as the first multimedia segment is played. Optionally, a highlighting manner is not limited, for example, marking may be adopted.

Optionally, the step that the playback triggering operation of the user is received may include the following step: a first triggering operation of the user on the first multimedia segment is received, wherein the first triggering operation is an operation for the first multimedia segment. Optionally, the step that the playback triggering operation of the user is received includes the following step: a second triggering operation of the user on a first subtitle sentence is received, wherein the first subtitle sentence is a subtitle sentence in the subtitle segment corresponding to the first multimedia segment. Optionally, the second triggering operation is an operation for the first subtitle sentence.

The playback triggering operation may be a variety of operations. In the embodiment of the present disclosure, the playback triggering operation is described with the above-mentioned first triggering operation or second triggering operation as an example, the first triggering operation may be a clicking or hovering operation for the first multimedia segment, and the second triggering operation may be a clicking or hovering operation for the first subtitle sentence, wherein the above-mentioned clicking or hovering operation is only used as an example. When the first triggering operation of the user on the first multimedia segment is received, the playback triggering operation of the user is received, the first multimedia segment corresponding to the playback triggering operation in the target multimedia is played from the beginning, and the subtitle sentences corresponding to the playing progress of the first multimedia segment are highlighted in sequence based on the time stamp of each subtitle sentence in the subtitle segment corresponding to the first multimedia segment in a process of playing the first multimedia segment.

Or, when the second triggering operation of the user on the first subtitle sentence is received, the playback triggering operation of the user may also be received, which differs from above description in that the first multimedia segment is played based on the time stamp of the first subtitle sentence, that is, the first multimedia segment is not played from the beginning, but is played from the time stamp of the first subtitle sentence that is highlighted, and subtitle sentences behind the first subtitle sentence may also be highlighted in sequence as the first multimedia segment is played.

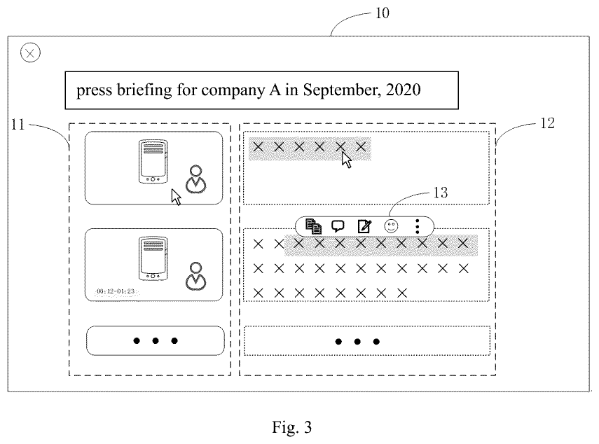

Exemplarily, FIG. 3 is a schematic diagram of another content display interface provided in an embodiment of the present disclosure. Referring to FIG. 3, an arrow in the first display area 11 in the figure may represent the playback triggering operation, an arrow in the first multimedia segment may represent the first triggering operation, and an arrow in the first subtitle segment in the second display area 12 may represent the second triggering operation. When the above-mentioned first triggering operation or second triggering operation is received, the first multimedia segment may be played in a mute manner. For example, a corresponding time range “00:00-00:11” is hidden in the process of playing the first multimedia segment in the figure, and the corresponding subtitle sentences are highlighted in sequence with the playing progress. A background color may be added for the highlighting in the figure.

By triggering a multimedia segment or a subtitle sentence as above, the playback triggering for the target multimedia may be implemented. The multimedia segment may be played, and the corresponding subtitles in the playing process can also be linked to be highlighted, so that linkage interaction between the multimedia and the subtitles can be implemented, thereby making the user better know about the content of the multimedia, and improving the user's browsing experience.

In some embodiments, the multimedia browsing method may further include the following steps: a non-playback triggering operation of the user on a second multimedia segment in the first display area is received; and a second subtitle sentence corresponding to a time stamp when the non-playback triggering operation is performed is highlighted. Optionally, the non-playback triggering operation includes an operation on a play timeline of the second multimedia segment. Optionally, the second multimedia segment is a video segment, the method may further include the following step: a video frame corresponding to the time stamp when the non-playback triggering operation is performed is displayed on the play timeline of the second multimedia segment. Optionally, highlighting is performed in at least one manner of marking, bolding and underlining.

The non-playback triggering operation is different from the playback triggering operation. The non-playback triggering operation may be understood as an operation by which multimedia play may not be triggered, that is, the operation cannot change the current play state of the multimedia. The non-playback triggering operation may be performed in a plurality of specific forms, for example, the non-playback triggering operation may be a hovering operation on the play timeline of the second multimedia segment. The second multimedia segment is any multimedia segment included by the target multimedia. After the non-playback triggering operation of the user on the second multimedia segment is received, the second subtitle sentence corresponding to the non-playback triggering operation may be determined, and the second subtitle sentence is highlighted. Moreover, when the second multimedia segment is a video segment, a time stamp corresponding to the non-playback triggering operation may be determined after the non-playback triggering operation is received, and a video frame corresponding to the above-mentioned time stamp is displayed on the play timeline of the second multimedia segment, so that the user can correspondingly browse the subtitle sentence and the video frame which correspond to a time point when the current non-playback triggering operation is performed. In the embodiment of the present disclosure, a specific manner of highlighting is not limited, for example, the highlighting may be performed in at least one manner of marking, bolding and underlining.

By triggering at certain time on the play timelines of the multimedia segments as above, a subtitle corresponding to the time may be highlighted, and when the second multimedia segment is a video segment, a video frame at the time may also be displayed, so that the user can purposefully know about a multimedia picture and a corresponding subtitle sentence at a time according to an actual requirement, which is more in line with an actual scenario requirement and improves the user experience.

In some embodiments, the multimedia browsing method may further include the following steps: a selection operation of the user on a target subtitle sentence in the second display area is received, and an operable button is displayed; and a target operation corresponding to the operable button is performed on the target subtitle sentence after a triggering operation of the user on the operable button is received. Optionally, the operable button may include at least one of a copying button, a commenting button, an editing button and an expression button, and the target operation corresponding to the operable button includes at least one of a copying operation, a commenting operation, an editing operation and an expression posting operation.

The selection operation refers to an selected operation combined by clicking and dragging performed in the subtitle content. A text corresponding to the selection operation may be determined by detecting a cursor position, and the target subtitle sentence is the above-mentioned text. The operable button refers to a button preset and configured to implement a specific operation on subtitles, and various operable buttons may be included, which are not specifically limited. The operable button in the embodiment of the present disclosure may include at least one of a copying button, a commenting button, an editing button and an expression button, and each operable button corresponds to a different operation. After the selection operation of the user on the target subtitle sentence in the second display area is received, at least one operable button may be displayed for the user. After triggering the operable button, the user may receive the triggering operation to perform a corresponding target operation on the target subtitle sentence corresponding to the above-mentioned selection operation. For example, when triggering for the commenting button by the user is received, the target subtitle sentence may be commented, and for another example, when triggering for the expression button by the user is received, an expression may be posted for the target subtitle sentence. It can be understood that the editing button is only made for a user who has the right to trigger to perform edition, but other users cannot perform edition.

Exemplarily, referring to FIG. 3 in which a display box 13 including four operable buttons is displayed in the second display area 12, the copying button, the commenting button, the editing button and the expression button are respectively displayed from left to right in the display box 13, the target subtitle sentence corresponding to the selection operation is a statement added with a background color below the display box 13, and the user can trigger any operable button to implement a corresponding operation for the target subtitle sentence. It can be understood that the operable buttons displayed in FIG. 3 are only exemplary, and more operable buttons can be displayed by clicking more buttons (three points) on the rightmost side of the display box 13.

By above-mentioned operable button, various operations of the user, such as commenting, editing, expression posting, copying, or the like for the subtitle content can be supported, more interaction possibilities are provided, and the user can perform interaction according to an actual requirement, thereby further improving the user's interaction experience effect.

Optionally, when the operable button is the editing button, and the target operation is the editing operation, the multimedia browsing method may further include the following step: inlaid subtitles in the multimedia segments at the time stamp of the target subtitle sentence are adjusted based on the target subtitle sentence obtained after the editing operation. The inlaid subtitles refer to subtitles combined in the multimedia segments in a manner such as encoding, and the inlaid subtitles are synchronously displayed in the multimedia segments when the multimedia segments are played. In the embodiment of the present disclosure, since the user may perform edition, i.e., operations such as modification and addition, on the target subtitle sentence in the subtitle content, the inlaid subtitle corresponding to the time stamp of the target subtitle sentence in the multimedia segments obtained after edition may also be modified as an edited target subtitle sentence to ensure that the subtitle content is the same when being displayed at different positions, so that a poor user' experience effect caused by different subtitles at different positions is avoided, and the subtitle displaying accuracy is also improved.

In some embodiments, the multimedia browsing method may further include the following steps: at least one keyword is displayed, wherein the keywords are obtained by performing keyword extraction on each of the subtitle segments; and a triggering operation of the user on a target keyword in the at least one keyword is received, and the target keywords in the respective subtitle segments are highlighted, wherein at least one target keyword is provided.

The keywords may be obtained by performing keyword extraction on each of the subtitle segments in the subtitle content, and a specific extraction rule is not limited, for example, the extraction rule may be that the extraction may be performed based on a number. In the embodiment of the present disclosure, the keywords may also be displayed in the content display interface, and the number of the keywords is not limited. After the triggering operation of the user on the target keywords is received, the target keywords included in the respective subtitle segments are highlighted. A manner of highlighting is not limited either.

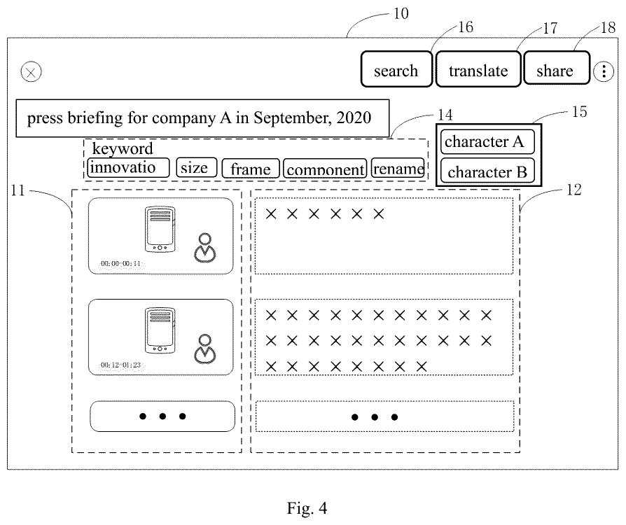

Exemplarily, FIG. 4 is a schematic diagram of yet another content display interface provided in an embodiment of the present disclosure. Referring to FIG. 4 in which the content display interface 10 may include a keyword display area 14, five keywords which are respectively “innovation”, “size”, “frame”, “component” and “rename” are exemplarily displayed in the keyword display area. When the user triggers one of the keywords such as “innovation”, “innovation” in each of the subtitle segments in the second display area 12 is highlighted.

Optionally, the multimedia browsing method may further include the following step: the multimedia segments corresponding to the subtitle segments where the respective target keywords are located are played based on time stamps of the respective target keywords. Optionally, the multimedia browsing method may further include the following step: a triggering operation of the user on at least one target keyword is received; and the multimedia segments corresponding to the subtitle segments where a set keyword is located are played based on a time stamp of a triggered target keyword.

After the triggering operation of the user on the target keywords is received, since the target keywords have different time stamps in the respective subtitle segments, a plurality of multimedia segments corresponding to the subtitle segments where each of the target keywords is located may be played at the same time based on the time stamp of each of the target keywords. Or, after the triggering operation of the user on the target keywords is received, if the triggering operation of the user on the at least one target keyword is received again, it is possible that multimedia segments corresponding to subtitle segments where a set keyword is located are only played based on a time stamp of the set keyword. That is, after the user triggers the target keywords, if the user does not perform triggering again, the multimedia segments corresponding to each of the target keywords may be played. If the user triggers one of at least two target keywords again, only the multimedia segments corresponding to the keyword triggered again by the user are played.

After the subtitle content is subjected to keyword extraction, is displayed and triggered as above, linkage interaction may be performed in the subtitles and the multimedia, so that the user intuitively browses a subtitle position and a multimedia position where the keywords are located, which is more beneficial to satisfying individual user requirements.

In some embodiments, the multimedia browsing method may further include the following steps: automatic speech recognition is performed on the target multimedia to determine at least two multimedia characters; each of the multimedia segments and each of the subtitle segments are divided according to the multimedia characters; and each of the divided multimedia segments and each of the divided subtitle segments are interactively triggered based on the multimedia characters. Optionally, the multimedia browsing method may further include the following step: character information of each of the multimedia characters is displayed; a triggering operation of the user on character information of a target multimedia character is received; and subtitle sub-segments relevant to the target multimedia character are highlighted.

The multimedia characters refer to speakers included in the target multimedia, and the included speakers may be determined by performing automatic speech recognition, such as tone recognition, on the target multimedia. In the embodiment of the present disclosure, the at least two included multimedia characters may be determined by performing automatic speech recognition on the target multimedia. Then, each of the multimedia segments and each of the subtitle segments may be divided by semantic analysis based on the multimedia characters, so that each of the multimedia segments is divided into multimedia sub-segments corresponding to the different multimedia characters, and each of the subtitle segments is divided into subtitle sub-segments corresponding to the different multimedia characters. Subsequently, each of the divided multimedia segments and each of the divided subtitle segments may be interactively triggered based on the multimedia characters. The character information of each of the multimedia characters is displayed in the content display interface, and the character information is configured to characterize the multimedia characters. The different multimedia characters have different character information, and the character information may include a character name and other information, which is not specifically limited. After the triggering operation of the user on the character information of the target multimedia character in the at least two multimedia characters is received, the subtitle sub-segments in each of the subtitle segments divided by the target multimedia character may be highlighted, and the manner of highlighting is not limited.

Exemplarily, referring to FIG. 4 in which the content display interface 10 may include a character information display area 15, character names, which are respectively “character A” and “character B”, of two multimedia characters are exemplarily displayed in the character information display area 15. When the user triggers one of the character names, for example, the user triggers the “character A”, subtitle sub-segments of the “character A” in each of the subtitle segments in the second display area 12 are all highlighted.

Optionally, the multimedia browsing method may further include the following step: multimedia sub-segments in each of the multimedia segments divided by the target multimedia character are played. Optionally, the multimedia browsing method may further include the following step: a triggering operation of the user on a target subtitle sub-segment is received; and multimedia sub-segments corresponding to the target subtitle sub-segment are played based on a time stamp of the target subtitle sub-segment.

After the triggering operation of the user on the character information of the target multimedia character in the at least two multimedia characters is received, since the target multimedia character has corresponding multimedia sub-segments in each of the multimedia segments, the multimedia sub-segments in each of the multimedia segments divided by the target multimedia character may be played at the same time, and when the target multimedia character in one of the multimedia segments has a plurality of multimedia sub-segments, the multimedia sub-segments may be played at intervals. Or, after the triggering operation of the user on the character information of the target multimedia character in the at least two multimedia characters is received, if the triggering operation of the user on the target subtitle sub-segment in the at least two subtitle sub-segments of the target multimedia character is received again, it is possible that only the multimedia sub-segments corresponding to the target subtitle sub-segment are played based on the time stamp of the target subtitle sub-segment. That is, after the user triggers the character information of the target multimedia character, if the user does not perform triggering again, the multimedia sub-segments of the target multimedia character in each of the multimedia segments may be played. If the user triggers the target subtitle sub-segment in the at least two subtitle sub-segments again, only the multimedia sub-segments corresponding to the target subtitle sub-segment in the at least two subtitle sub-segments triggered again by the user are played.

After the character information included in the multimedia is determined, displayed and triggered as above, linkage interaction between the subtitle and multimedia corresponding to the character information may be performed, so that the user intuitively browses a subtitle position and a multimedia position where the character is located, which is more beneficial to satisfying individual user requirements, so that the interaction experience is further improved.

In some embodiments, the multimedia browsing method may further include the following step: an interaction content of the target multimedia is displayed on the content display interface, wherein the interaction content includes a comment and/or an expression. The interaction content may include an interaction content for the target multimedia and/or an interaction content of the user on the subtitle content of the target multimedia. In the embodiment of the present disclosure, the interaction content for the target multimedia and/or the interaction content for the subtitle content of the target multimedia may also be displayed in the content display interface, and a specific display position is not limited, for example, an interaction content display area may be disposed on a right side of the content display interface to display the interaction content. Optionally, for the display of the interaction content, different multimedia segments and corresponding subtitle segments may also be divided for display, and the interaction content for the target multimedia and the interaction content for the subtitle content of the target multimedia in the interaction content may be displayed in different manners, for example, may be displayed with different colors.

By displaying the interaction content for the target multimedia in the content display interface as above, a user may intuitively browse historical interaction information of the multimedia and know about the emphasis of the multimedia segments from a perspective of interaction, which is more beneficial for a user to know about the multimedia and the corresponding subtitles as a whole, so that a user's browsing experience effect is further improved.

In addition, referring to FIG. 4, functional buttons such as a search button 16, a translation button 17 and a sharing button 18, may also be disposed in the content display interface 10, and when a user triggers one of the buttons, the corresponding operation may be performed. When triggering the search button 16 and inputting a search word, the user may search the search word. When triggering the translation button 17, the user may translate all texts in the entire content display interface 10. Specifically, an initial speech may be translated into a target language, and a specific translation language may be set according to an actual situation. When triggering the sharing button 18, the user may share the content display interface 10 to other users as a whole. The content display interface 10 in FIG. 4 is only exemplary, and the content display interface 10 may be set according to an actual situation and a user requirement.

By using the multimedia browsing method provided in the embodiment of the present disclosure, the user requirement for rapidly browsing the multimedia and the subtitle content in various specific scenarios where it is inconvenient to play the multimedia can be satisfied, and the at least two multimedia segments obtained by splitting the content of the multimedia and the subtitle segments corresponding to the multimedia segments, are displayed, so that the user intuitively browses the subtitle segments corresponding to the multimedia segments, and the efficiency that the user knows about the entire content of the multimedia is improved. Moreover, when the subtitle segments and the multimedia segments are triggered by the user, linkage interaction in various manners may be implemented, so that the user may intuitively determine a corresponding relationship between each of the subtitles and the multimedia from various perspectives and multiple granularities, which is more beneficial to satisfying individual user requirements, thereby further improving the interaction experience. The subtitle content may support user's operations such as editing, commenting and copying, so that the interaction functions are more diversified. The keywords and the plurality of multimedia characters may be determined by performing keyword extraction on the subtitle content and performing the automatic speech recognition on the multimedia, and the multimedia and the subtitles are screened and browsed from the perspectives of the keywords or the multimedia characters by triggering the keywords or the multimedia characters, so that the user more purposefully browses the relevant content, which is more beneficial to satisfying individual user requirements.

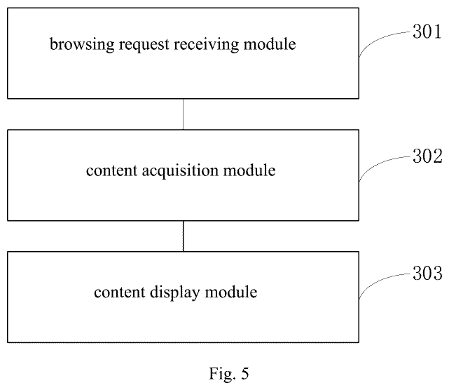

FIG. 5 is a schematic structural diagram of a multimedia browsing apparatus provided in an embodiment of the present disclosure. The apparatus may be implemented by software and/or hardware and is generally integrated in an electronic device. As shown in FIG. 5, the apparatus includes:
a browsing request receiving module 301 configured to receive a subtitle browsing request for target multimedia;
a content acquisition module 302 configured to acquire at least two multimedia segments of the target multimedia and subtitle segments corresponding to the multimedia segments, wherein each of the multimedia segments corresponds to at least one of the subtitle segments; and
a content display module 303 configured to display the multimedia segments in a first display area in a content display interface, and display the subtitle segments corresponding to the multimedia segments in a second display area.

Optionally, the apparatus further includes a subtitle segment module, configured to:
perform automatic speech recognition on the target multimedia to acquire a subtitle content; and
perform semantic splitting on the subtitle content to determine at least two subtitle segments.

Optionally, the apparatus further includes a multimedia segment module, configured to:
split the target multimedia according to time stamps corresponding to the subtitle segments to determine at least two multimedia segments.

Optionally, the apparatus further includes a segment module, configured to:
split the target multimedia according to a predetermined rule to determine at least two multimedia segments; and
determine at least two corresponding subtitle segments according to the multimedia segments.

Optionally, the apparatus further includes a time stamp module, configured to:
determine a time stamp of each subtitle sentence included in the subtitle segments, wherein the subtitle sentence includes at least one word or phrase.

Optionally, the apparatus further includes a play module, configured to:
receive a playback triggering operation of a user, and playing a first multimedia segment corresponding to the playback triggering operation in the target multimedia.

Optionally, when the target multimedia is a video, the playing is performed in a mute manner.

Optionally, the apparatus further includes a subtitle highlighting module, configured to:
highlight subtitle sentences corresponding to a playing progress of the first multimedia segment in sequence based on a time stamp of each subtitle sentence in the subtitle segment corresponding to the first multimedia segment in the process of playing the first multimedia segment.

Optionally, the play module is specifically configured to:
receive a first triggering operation of the user on the first multimedia segment, wherein the first triggering operation is an operation for the first multimedia segment.

Optionally, the play module is specifically configured to:
receive a second triggering operation of the user on a first subtitle sentence, wherein the first subtitle sentence is a subtitle sentence in the subtitle segment corresponding to the first multimedia segment.

Optionally, the second triggering operation is an operation for the first subtitle sentence.

Optionally, the apparatus further includes a non-play module, configured to:
receive a non-playback triggering operation of the user on a second multimedia segment in the first display area; and
highlight a second subtitle sentence corresponding to a time stamp when the non-playback triggering operation is performed.

Optionally, the non-playback triggering operation includes an operation on a play timeline of the second multimedia segment.

Optionally, the second multimedia segment is a video segment, the apparatus further includes a picture frame module, configured to:
display a video frame corresponding to the time stamp when the non-playback triggering operation is performed on the play timeline of the second multimedia segment.

Optionally, the highlighting is performed in at least one manner of marking, bolding and underlining.

Optionally, the apparatus further includes a subtitle interaction module, configured to:
receive a selection operation of the user on a target subtitle sentence in the second display area, and display an operable button; and
perform a target operation corresponding to the operable button on the target subtitle sentence after receiving a triggering operation of the user on the operable button.

Optionally, the operable button includes at least one of a copying button, a commenting button, an editing button and an expression button, and the target operation corresponding to the operable button includes at least one of a copying operation, a commenting operation, an editing operation and an expression posting operation.

Optionally, when the operable button is the editing button, the target operation is the editing operation, and the apparatus further includes a subtitle adjustment module, configured to:
adjust inlaid subtitles in the multimedia segments having a time-stamped correspondence with the target subtitle sentence based on the target subtitle sentence obtained after the editing operation.

Optionally, the apparatus further includes a keyword module, configured to:
display at least one keyword, wherein the keywords are obtained by performing keyword extraction on each of the subtitle segments; and
receive a triggering operation of the user on a target keyword in the at least one keyword, and highlight the target keyword in each of the subtitle segments, wherein at least one target keyword is provided.

Optionally, the apparatus further includes a keyword multimedia module, configured to:
play, based on a time stamp of each of the target keywords, the multimedia segments corresponding to the subtitle segments where each of the target keywords is located.

Optionally, the apparatus further includes a set keyword module, configured to:
receive a triggering operation of the user on at least one target keyword; and
play, based on a time stamp of a triggered target keyword, the multimedia segments corresponding to the subtitle segments where a set keyword is located.

Optionally, the apparatus further includes a character module, configured to:
perform automatic speech recognition on the target multimedia to determine at least two multimedia characters;
divide each of the multimedia segments and each of the subtitle segments according to the multimedia characters; and
interactively trigger each of the divided multimedia segments and each of the divided subtitle segments based on the multimedia characters.

Optionally, the apparatus further includes a character triggering module, configured to:
display character information of each of the multimedia characters;
receive a triggering operation of the user on character information of a target multimedia character; and
highlight subtitle sub-segments relevant to the target multimedia character.

Optionally, the apparatus further includes a first play module, configured to:
play multimedia sub-segments in each of the multimedia segments divided by the target multimedia character.

Optionally, the apparatus further includes a second play module, configured to:
receive a triggering operation of the user on a target subtitle sub-segment; and
play multimedia sub-segments corresponding to the target subtitle sub-segment based on a time stamp of the target subtitle sub-segment.

Optionally, the apparatus further includes an interaction display module, configured to:
display an interaction content of the target multimedia on the content display interface, wherein the interaction content includes a comment and/or an expression.

The multimedia browsing apparatus provided in the embodiment of the present disclosure can be configured to execute the multimedia browsing method provided in any embodiment of the present disclosure and has corresponding functional modules and beneficial effects in the executing method.

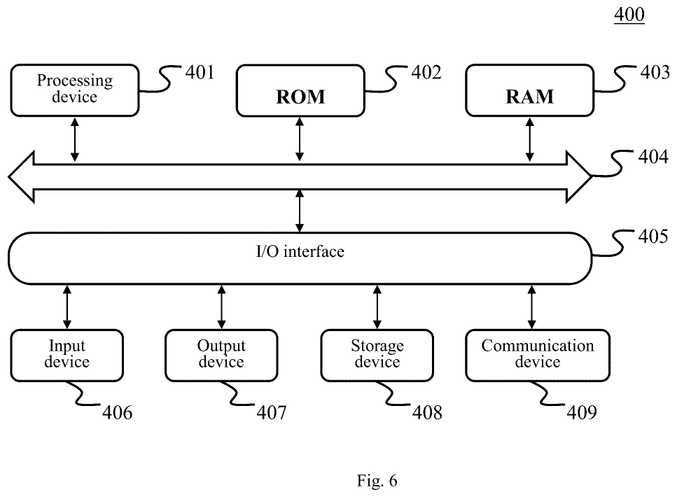

FIG. 6 is a schematic structural diagram of an electronic device provided by embodiments of the present disclosure. Referring next to FIG. 6, it shows a schematic structural diagram of an electronic device 400 suitable for implementing an embodiment of the present application. The electronic device 400 in the embodiments of the present disclosure may include, but is not limited to, mobile terminals such as mobile phones, laptops, digital broadcast receivers, PDAs (personal digital assistants), PADs (tablet computers), PMPs (portable multimedia players), vehicle terminals (such as vehicle navigation terminals), and fixed terminals such as digital TVs, desktop computers, and the like. The electronic device shown in FIG. 6 is only an example, and should not impose any limitations on the functions and scope of use of the embodiments of the present application.

As shown in FIG. 6, an electronic device 400 may include a processing device (eg, a central processing unit, a graphics processor, etc.) 401 that may execute various appropriate actions and processes according to a program stored in a read only memory (ROM) 402 or a program be loaded into random access memory (RAM) 403 from a storage device 408. In the RAM 403, various programs and data necessary for the operation of the electronic device 400 are also stored. The processing device 401, the ROM 402, and the RAM 403 are connected to each other through a bus 404. An input/output (I/O) interface 405 is also connected to the bus 404.

Typically, the following devices can be connected to the I/O interface 405: an input device 406 including, for example, a touch screen, touch pad, keyboard, mouse, etc.; an output device 407 including, for example, a Liquid Crystal Display (LCD), speaker, vibrator, etc.; a storage device 408, including, for example, magnetic tape, hard disk, etc.; and a communication device 409. The communication device 409 may allow electronic device 400 to communicate wirelessly or by wire with other devices to exchange data. Although FIG. 6 shows an electronic device 400 having various devices, it should be understood that not all of the illustrated devices are required to be implemented or provided. More or fewer devices may alternatively be implemented or provided.

In particular, according to embodiments of the present application, the processes described above with reference to the flowcharts may be implemented as computer software programs. For example, embodiments of the present application include a computer program product comprising a computer program carried on a computer-readable medium, the computer program containing program code for performing the method illustrated in the flowchart. In such an embodiment, the computer program may be downloaded and installed from the network via the communication device 409, or from the storage device 408, or from the ROM 402. When the computer program is executed by the processing device 401, the above-mentioned functions defined in the methods of the embodiments of the present application are executed.

It should be noted that the computer-readable medium described in the embodiments of the present application may be a computer-readable signal medium or a computer-readable storage medium, or any combination thereof. The computer-readable storage medium can be, for example, but not limited to, an electrical, magnetic, optical, electromagnetic, infrared, or semiconductor system, apparatus or device, or a combination of thereof. More specific examples of computer readable storage media may include, but are not limited to, electrical connections with one or more wires, portable computer disks, hard disks, random access memory (RAM), read only memory (ROM), erasable Programmable read only memory (EPROM or flash memory), optical fiber, portable compact disk read only memory (CD-ROM), optical storage devices, magnetic storage devices, or any suitable combination thereof. In the embodiments of the present application, a computer-readable storage medium may be any tangible medium that contains or stores a program that can be used by or in conjunction with an instruction execution system, apparatus, or device. While in embodiments of the present application, a computer-readable signal medium may include a data signal in baseband or propagated as part of a carrier wave, carrying computer-readable program code therein. Such propagated data signals may take a variety of forms, including but not limited to electromagnetic signals, optical signals, or any suitable combination thereof. A computer-readable signal medium can also be any computer-readable medium other than a computer-readable storage medium, the computer-readable signal medium can transmit, propagate, or transport the program for use by or in connection with the instruction execution system, apparatus, or device. The program code contained on the computer-readable medium can be transmitted by any suitable medium, including but not limited to: electric wire, optical cable, RF (Radio Frequency, radio frequency), etc., or any suitable combination thereof.

In some embodiments, clients and servers can communicate using any currently known or future network protocol, such as HTTP (HyperText Transfer Protocol), and can be interconnected with any form or medium of digital data communication, such as a communication network. Examples of communication networks include a local area network (“LAN”), a wide area network (“WAN”), an Internet (for example, the Internet), and an end-to-end network (for example, an ad hoc end-to-end network), as well as any network currently known or developed in the future.

The computer-readable medium may be included in the above-mentioned electronic device; or may exist alone without being assembled into the electronic device.

The computer-readable medium carries one or more programs, and when the one or more programs are executed by the electronic device, cause the electronic device to: receive a subtitle browsing request for target multimedia; acquire at least two multimedia segments of the target multimedia and subtitle segments corresponding to the multimedia segments, wherein the multimedia segments corresponds to at least one of the subtitle segments; and display the multimedia segments in a first display area in a content display interface, and displaying the subtitle segments corresponding to the multimedia segments in a second display area.

Computer program code for performing the operations of the embodiments of the present application may be written in one or more programming languages, including object-oriented programming languages—such as Java, Smalltalk, C++, and including conventional procedural programming languages—such as the “C” language or similar programming languages. The program code may execute entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or may be connected to an external computer (eg, using an Internet service provider via Internet connection).

The flowchart and block diagrams in the Figures illustrate the architecture, functionality, and operation of possible implementations of systems, methods and computer program products according to various embodiments of the present application. In this regard, each block in the flowchart or block diagrams may represent a module, program segment, or portion of code that contains one or more executable instructions for implementing the specified logical functions. It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It is also noted that each block of the block diagrams and/or flowchart, and combinations of blocks in the block diagrams and/or flowchart, can be implemented in dedicated hardware-based systems that perform the specified functions or operations, or can be implemented in a combination of dedicated hardware and computer instructions.

The units involved in the embodiments of the present application may be implemented in a software manner, and may also be implemented in a hardware manner. The names of these units do not constitute a limitation of the unit itself under certain circumstances.

The functions described above can be performed at least partially by one or more hardware logic components. For example, unrestricted, the types of hardware logic components that can be used include field programmable gate arrays (FPGA), dedicated integrated circuits (ASIC), dedicated standard products (ASSPs), on-chip systems (SOCs), complex programmable logic devices (CPLDs), and so on.

In the context of the present disclosure, a machine-readable medium may be a tangible medium that may contain or store a program for use by or in conjunction with an instruction-executing system, apparatus, or device. The machine-readable medium may be a machine-readable signal medium or a machine-readable storage medium. The machine-readable storage medium may include, but not limited to, an electrical, magnetic, optical, electromagnetic, infrared, or semiconductor system, apparatus or device, or a combination of thereof. More specific examples of machine-readable storage media may include, but are not limited to, electrical connections with one or more wires, portable computer disks, hard disks, random access memory (RAM), read only memory (ROM), erasable Programmable read only memory (EPROM or flash memory), optical fiber, portable compact disk read only memory (CD-ROM), optical storage devices, magnetic storage devices, or any suitable combination thereof.

In accordance with one or more embodiments of the present disclosure, a multimedia browsing method is provided, the multimedia browsing method comprises: receiving a subtitle browsing request for target multimedia; acquiring at least two multimedia segments of the target multimedia and subtitle segments corresponding to the multimedia segments, wherein the multimedia segments corresponds to at least one of the subtitle segments; and displaying the multimedia segments in a first display area in a content display interface, and displaying the subtitle segments corresponding to the multimedia segments in a second display area.

Accordance with one or more embodiments of the present disclosure, the multimedia browsing method further comprising: performing automatic speech recognition on the target multimedia to acquire a subtitle content; and performing semantic splitting on the subtitle content to determine at least two subtitle segments.

Accordance with one or more embodiments of the present disclosure, the multimedia browsing method further comprising: splitting the target multimedia according to time stamps corresponding to the subtitle segments to determine at least two multimedia segments.

Accordance with one or more embodiments of the present disclosure, the multimedia browsing method further comprising: splitting the target multimedia according to a predetermined rule to determine at least two multimedia segments; and determining at least two corresponding subtitle segments according to the multimedia segments.

Accordance with one or more embodiments of the present disclosure, the multimedia browsing method further comprising: determining a time stamp of each subtitle sentence comprised in the subtitle segments, wherein the subtitle sentence comprises at least one word or phrase.

Accordance with one or more embodiments of the present disclosure, the multimedia browsing method further comprising: receiving a playback triggering operation of a user, and playing a first multimedia segment corresponding to the playback triggering operation in the target multimedia.

Accordance with one or more embodiments of the present disclosure, wherein when the target multimedia is a video, the playing is performed in a mute manner.

Accordance with one or more embodiments of the present disclosure, the multimedia browsing method further comprising: highlighting subtitle sentences corresponding to a playing progress of the first multimedia segment in sequence based on the time stamp of each subtitle sentence in the subtitle segment corresponding to the first multimedia segment in a process of playing the first multimedia segment.

Accordance with one or more embodiments of the present disclosure, wherein receiving the playback triggering operation of the user comprises: receiving a first triggering operation of the user on the first multimedia segment, wherein the first triggering operation is an operation for the first multimedia segment.

Accordance with one or more embodiments of the present disclosure, wherein receiving the playback triggering operation of the user comprises: receiving a second triggering operation of the user on a first subtitle sentence, wherein the first subtitle sentence is a subtitle sentence in the subtitle segment corresponding to the first multimedia segment.

Accordance with one or more embodiments of the present disclosure, wherein the second triggering operation is an operation for the first subtitle sentence.

Accordance with one or more embodiments of the present disclosure, the multimedia browsing method further comprising: receiving a non-playback triggering operation of the user on a second multimedia segment in the first display area; and highlighting a second subtitle sentence corresponding to a time stamp when the non-playback triggering operation is performed.

Accordance with one or more embodiments of the present disclosure, wherein the non-playback triggering operation comprises an operation on a play timeline of the second multimedia segment.

Accordance with one or more embodiments of the present disclosure, wherein the second multimedia segment is a video segment, the method further comprises: displaying a video frame corresponding to the time stamp when the non-playback triggering operation is performed on the play timeline of the second multimedia segment.

Accordance with one or more embodiments of the present disclosure, wherein the highlighting is performed in at least one manner of marking, bolding and underlining.

Accordance with one or more embodiments of the present disclosure, the multimedia browsing method further comprising: receiving a selection operation of the user on a target subtitle sentence in the second display area, and displaying an operable button; and performing a target operation corresponding to the operable button on the target subtitle sentence after receiving a triggering operation of the user on the operable button.

Accordance with one or more embodiments of the present disclosure, wherein the operable button comprises at least one of a copying button, a commenting button, an editing button and an expression button, and the target operation corresponding to the operable button comprises at least one of a copying operation, a commenting operation, an editing operation and an expression posting operation.

Accordance with one or more embodiments of the present disclosure, wherein when the operable button is the editing button, the target operation is the editing operation, and the method further comprises: adjusting inlaid subtitles in the multimedia segments having a time-stamped correspondence with the target subtitle sentence based on the target subtitle sentence obtained after the editing operation.

Accordance with one or more embodiments of the present disclosure, the multimedia browsing method further comprising: displaying at least one keyword, wherein the keywords are obtained by performing keyword extraction on each of the subtitle segments; and receiving a triggering operation of the user on target keywords in the at least one keyword, and highlighting the target keywords in each of the subtitle segments, wherein at least one target keyword is provided.

Accordance with one or more embodiments of the present disclosure, the multimedia browsing method further comprising: playing, based on a time stamp of each of the target keywords, the multimedia segments corresponding to the subtitle segments where the target keywords are located.

Accordance with one or more embodiments of the present disclosure, the multimedia browsing method further comprising: receiving a triggering operation of the user on the at least one target keyword; and playing, based on a time stamp of a triggered target keyword, a multimedia segment corresponding to a subtitle segment where a set keyword is located.

Accordance with one or more embodiments of the present disclosure, the multimedia browsing method further comprising: performing automatic speech recognition on the target multimedia to determine at least two multimedia characters; dividing each of the multimedia segments and each of the subtitle segments according to the multimedia characters; and interactively triggering each of the divided multimedia segments and each of the divided subtitle segments based on the multimedia characters.

Accordance with one or more embodiments of the present disclosure, the multimedia browsing method further comprising: displaying character information of each of the multimedia characters; receiving a triggering operation of the user on character information of a target multimedia character; and highlighting subtitle sub-segments relevant to the target multimedia character.

Accordance with one or more embodiments of the present disclosure, the multimedia browsing method further comprising: playing multimedia sub-segments in each of the multimedia segments divided by the target multimedia character.

Accordance with one or more embodiments of the present disclosure, the multimedia browsing method further comprising: receiving a triggering operation of the user on a target subtitle sub-segment; and playing multimedia sub-segments corresponding to the target subtitle sub-segment based on a time stamp of the target subtitle sub-segment.

Accordance with one or more embodiments of the present disclosure, the multimedia browsing method comprising: displaying an interaction content of the target multimedia on the content display interface, wherein the interaction content comprises a comment and/or an expression.

Accordance with one or more embodiments of the present disclosure, a multimedia browsing apparatus is provided, the multimedia browsing apparatus comprises: a browsing request receiving module configured to receive a subtitle browsing request for target multimedia; a content acquisition module configured to acquire at least two multimedia segments of the target multimedia and subtitle segments corresponding to the multimedia segments, wherein the multimedia segments corresponds to at least one of the subtitle segments; and a content display module configured to display the multimedia segments in a first display area in a content display interface, and display the subtitle segments corresponding to the multimedia segments in a second display area.

Accordance with one or more embodiments of the present disclosure, the multimedia browsing apparatus further includes a subtitle segment module, configured to: perform automatic speech recognition on the target multimedia to acquire a subtitle content; and perform semantic splitting on the subtitle content to determine at least two subtitle segments.

Accordance with one or more embodiments of the present disclosure, the multimedia browsing apparatus further includes a multimedia segment module, configured to: split the target multimedia according to time stamps corresponding to the subtitle segments to determine at least two multimedia segments.

Accordance with one or more embodiments of the present disclosure, the multimedia browsing apparatus further includes a segment module, configured to: split the target multimedia according to a predetermined rule to determine at least two multimedia segments; and determine at least two corresponding subtitle segments according to the multimedia segments.

Accordance with one or more embodiments of the present disclosure, the multimedia browsing apparatus further includes a time stamp module, configured to: determine a time stamp of each subtitle sentence included in the subtitle segments, wherein the subtitle sentence includes at least one word or phrase.

Accordance with one or more embodiments of the present disclosure, the multimedia browsing apparatus further includes a play module, configured to: receive a playback triggering operation of a user, and playing a first multimedia segment corresponding to the playback triggering operation in the target multimedia.

Accordance with one or more embodiments of the present disclosure, when the target multimedia is a video, the playing is performed in a mute manner.

Accordance with one or more embodiments of the present disclosure, the multimedia browsing apparatus further includes a subtitle highlighting module, configured to: highlight subtitle sentences corresponding to a playing progress of the first multimedia segment in sequence based on a time stamp of each subtitle sentence in the subtitle segment corresponding to the first multimedia segment in the process of playing the first multimedia segment.

Accordance with one or more embodiments of the present disclosure, the play module is specifically configured to: receive a first triggering operation of the user on the first multimedia segment, wherein the first triggering operation is an operation for the first multimedia segment.

Accordance with one or more embodiments of the present disclosure, the play module is specifically configured to: receive a second triggering operation of the user on a first subtitle sentence, wherein the first subtitle sentence is a subtitle sentence in the subtitle segment corresponding to the first multimedia segment.

Accordance with one or more embodiments of the present disclosure, the second triggering operation is an operation for the first subtitle sentence.

Accordance with one or more embodiments of the present disclosure, the multimedia browsing apparatus further includes a non-play module, configured to: receive a non-playback triggering operation of the user on a second multimedia segment in the first display area; and highlight a second subtitle sentence corresponding to a time stamp when the non-playback triggering operation is performed.

Accordance with one or more embodiments of the present disclosure, the non-playback triggering operation includes an operation on a play timeline of the second multimedia segment.

Accordance with one or more embodiments of the present disclosure, the second multimedia segment is a video segment, the apparatus further includes a picture frame module, configured to: display a video frame corresponding to the time stamp when the non-playback triggering operation is performed on the play timeline of the second multimedia segment.

Accordance with one or more embodiments of the present disclosure, the highlighting is performed in at least one manner of marking, bolding and underlining.

Accordance with one or more embodiments of the present disclosure, the multimedia browsing apparatus further includes a subtitle interaction module, configured to: receive a selection operation of the user on a target subtitle sentence in the second display area, and display an operable button; and perform a target operation corresponding to the operable button on the target subtitle sentence after receiving a triggering operation of the user on the operable button.

Accordance with one or more embodiments of the present disclosure, the operable button includes at least one of a copying button, a commenting button, an editing button and an expression button, and the target operation corresponding to the operable button includes at least one of a copying operation, a commenting operation, an editing operation and an expression posting operation.

Accordance with one or more embodiments of the present disclosure, when the operable button is the editing button, the target operation is the editing operation, and the apparatus further includes a subtitle adjustment module, configured to: adjust inlaid subtitles in the multimedia segments having a time-stamped correspondence with the target subtitle sentence based on the target subtitle sentence obtained after the editing operation.

Accordance with one or more embodiments of the present disclosure, the multimedia browsing apparatus further includes a keyword module, configured to: display at least one keyword, wherein the keywords are obtained by performing keyword extraction on each of the subtitle segments; and receive a triggering operation of the user on a target keyword in the at least one keyword, and highlight the target keyword in each of the subtitle segments, wherein at least one target keyword is provided.

Accordance with one or more embodiments of the present disclosure, the multimedia browsing apparatus further includes a keyword multimedia module, configured to: play, based on a time stamp of each of the target keywords, the multimedia segments corresponding to the subtitle segments where each of the target keywords is located.

Accordance with one or more embodiments of the present disclosure, the multimedia browsing apparatus further includes a set keyword module, configured to: receive a triggering operation of the user on at least one target keyword; and play, based on a time stamp of a triggered target keyword, the multimedia segments corresponding to the subtitle segments where a set keyword is located.

Accordance with one or more embodiments of the present disclosure, the multimedia browsing apparatus further includes a character module, configured to: perform automatic speech recognition on the target multimedia to determine at least two multimedia characters; divide each of the multimedia segments and each of the subtitle segments according to the multimedia characters; and interactively trigger each of the divided multimedia segments and each of the divided subtitle segments based on the multimedia characters.

Accordance with one or more embodiments of the present disclosure, the multimedia browsing apparatus further includes a character triggering module, configured to: display character information of each of the multimedia characters; receive a triggering operation of the user on character information of a target multimedia character; and highlight subtitle sub-segments relevant to the target multimedia character.

Accordance with one or more embodiments of the present disclosure, the multimedia browsing apparatus further includes a first play module, configured to: play multimedia sub-segments in each of the multimedia segments divided by the target multimedia character.

Accordance with one or more embodiments of the present disclosure, the multimedia browsing apparatus further includes a second play module, configured to: receive a triggering operation of the user on a target subtitle sub-segment; and play multimedia sub-segments corresponding to the target subtitle sub-segment based on a time stamp of the target subtitle sub-segment.

Accordance with one or more embodiments of the present disclosure, the multimedia browsing apparatus further includes an interaction display module, configured to: display an interaction content of the target multimedia on the content display interface, wherein the interaction content includes a comment and/or an expression.

Accordance with one or more embodiments of the present disclosure, an electronic device is provided, the electronic device comprises: a processor, and a memory configured to store an executable instruction for the processor; wherein the processor is configured to read the executable instruction from the memory and execute the instruction to implement the multimedia browsing method provided by embodiments of the present disclosure.

Accordance with one or more embodiments of the present disclosure, a computer-readable storage medium is provided, wherein the storage medium stores a computer program, and the computer program is configured to perform the multimedia browsing method provided by embodiments of the present disclosure.

The above description is only a preferred embodiment of the present application and an illustration of the applied technical principles. It should be understood by those skilled in the art that the scope of the disclosure involved in the embodiments of the present application is not limited to the technical solution formed by the specific combination of the above technical features, and should also cover, without departing from the above inventive concept, the above Other technical solutions formed by any combination of technical features or their equivalent features. For example, a technical solution is formed by replacing the above features with the technical features disclosed (but not limited to) in the embodiments of the present application with similar functions.

Furthermore, although the operations are described in a particular order, this should not be understood as requiring the operations to be performed in the particular order shown or in a sequential order. Under certain circumstances, multitasking and parallel processing may be beneficial. Similarly, although the above discussion contains a number of specific implementation details, these should not be interpreted as limiting the scope of the disclosure. Certain features described in the context of separate embodiments may also be implemented in a single embodiment in combination. Instead, various features described in the context of a single embodiment may also be implemented in multiple embodiments individually or in any suitable sub combination.

Although the subject matter has been described in terms specific to the structural features and/or method logic actions, it should be understood that the subject matter defined in the appended claims is not necessarily limited to the specific features or actions described above. On the contrary, the specific features and actions described above are only examples of realizing the claims.

1. A multimedia browsing method, comprising:
receiving a subtitle browsing request for target multimedia;
acquiring at least two multimedia segments of the target multimedia and subtitle segments corresponding to the multimedia segments, wherein the multimedia segments corresponds to at least one of the subtitle segments; and
displaying the multimedia segments in a first display area in a content display interface, and displaying the subtitle segments corresponding to the multimedia segments in a second display area.

2. The method according to claim 1, further comprising:
performing automatic speech recognition on the target multimedia to acquire a subtitle content; and
performing semantic splitting on the subtitle content to determine at least two subtitle segments.

3. The method according to claim 2, further comprising:
splitting the target multimedia according to time stamps corresponding to the subtitle segments to determine at least two multimedia segments.

4. The method according to claim 1, further comprising:
splitting the target multimedia according to a predetermined rule to determine at least two multimedia segments; and
determining at least two corresponding subtitle segments according to the multimedia segments.

5. The method according to claim 1, further comprising:
determining a time stamp of each subtitle sentence comprised in the subtitle segments, wherein the subtitle sentence comprises at least one word or phrase.

6. The method according to claim 1, further comprising:
receiving a play triggering operation of a user, and playing a first multimedia segment corresponding to the playback triggering operation in the target multimedia.

7. (canceled)

8. The method according to claim 6, further comprising:
highlighting subtitle sentences corresponding to a playing progress of the first multimedia segment in sequence based on the time stamp of each subtitle sentence in the subtitle segment corresponding to the first multimedia segment in a process of playing the first multimedia segment.

9. The method according to claim 6, wherein receiving the playback triggering operation of the user comprises:
receiving a first triggering operation of the user on the first multimedia segment, wherein the first triggering operation is an operation for the first multimedia segment; or
receiving a second triggering operation of the user on a first subtitle sentence, wherein the first subtitle sentence is a subtitle sentence in the subtitle segment corresponding to the first multimedia segment.

10. (canceled)

11. (canceled)

12. The method according to claim 1, further comprising:
receiving a non-playback triggering operation of a user on a second multimedia segment in the first display area; and
highlighting a second subtitle sentence corresponding to a time stamp when the non-playback triggering operation is performed.

13. The method according to claim 12, wherein the non-playback triggering operation comprises an operation on a play timeline of the second multimedia segment.

14. The method according to claim 12, wherein the second multimedia segment is a video segment, the method further comprises:
displaying a video frame corresponding to the time stamp when the non-playback triggering operation is performed on the play timeline of the second multimedia segment.

15. (canceled)

16. The method according to claim 1, further comprising:
receiving a selection operation of a user on a target subtitle sentence in the second display area, and displaying an operable button; and
performing a target operation corresponding to the operable button on the target subtitle sentence after receiving a triggering operation of the user on the operable button.

17. The method according to claim 16, wherein the operable button comprises at least one of a copying button, a commenting button, an editing button and an expression button, and the target operation corresponding to the operable button comprises at least one of a copying operation, a commenting operation, an editing operation and an expression posting operation.

18. The method according to claim 17, wherein when the operable button is the editing button, the target operation is the editing operation, and the method further comprises:
adjusting inlaid subtitles in the multimedia segments having a time-stamped correspondence with the target subtitle sentence based on the target subtitle sentence obtained after the editing operation.

19. The method according to claim 1, further comprising:
displaying at least one keyword, wherein the keywords are obtained by performing keyword extraction on each of the subtitle segments; and
receiving a triggering operation of a user on a target keyword in the at least one keyword, and highlighting the target keyword in each of the subtitle segments, wherein at least one target keyword is provided.

20. The method according to claim 19, further comprising:
playing, based on a time stamp of each of the target keywords, the multimedia segments corresponding to the subtitle segments where the target keywords are located.

21. The method according to claim 19, further comprising:
receiving a triggering operation of the user on the at least one target keyword; and
playing, based on a time stamp of a triggered target keyword, a multimedia segment corresponding to a subtitle segment where a set keyword is located.

22. The method according to claim 1, further comprising:
performing automatic speech recognition on the target multimedia to determine at least two multimedia characters;
dividing each of the multimedia segments and each of the subtitle segments according to the multimedia characters; and
interactively triggering each of the divided multimedia segments and each of the divided subtitle segments based on the multimedia characters.

23. The method according to claim 22, further comprising:
displaying character information of each of the multimedia characters;
receiving a triggering operation of the user on character information of a target multimedia character; and
highlighting subtitle sub-segments relevant to the target multimedia character.

24. The method according to claim 23, further comprising:
playing multimedia sub-segments in each of the multimedia segments divided by the target multimedia character.

25. The method according to claim 23, further comprising:
receiving a triggering operation of the user on a target subtitle sub-segment; and
playing multimedia sub-segments corresponding to the target subtitle sub-segment based on a time stamp of the target subtitle sub-segment.

26. The method according to claim 1, comprising:
displaying an interaction content of the target multimedia on the content display interface, wherein the interaction content comprises a comment and/or an expression.

27. (canceled)

28. (canceled)

29. A non-transitory computer-readable storage medium, wherein the storage medium stores a computer program, and the computer program, when executed by a processor, cause the processor to perform operations comprising:
receiving a subtitle browsing request for target multimedia;
acquiring at least two multimedia segments of the target multimedia and subtitle segments corresponding to the multimedia segments, wherein the multimedia segments corresponds to at least one of the subtitle segments; and
displaying the multimedia segments in a first display area in a content display interface, and displaying the subtitle segments corresponding to the multimedia segments in a second display area.
